(19) United States
(12) Patent Application Publication
(10) Pub. No.: US 2009/0066443 A1
(43) Pub. Date: Mar. 12, 2009

(54) SIGNAL SELECTING DEVICE

(75) Inventors: Kunihiro KAWAI, Yokohama-shi (JP); Kei Satoh, Yokosuka-shi (JP); Hiroshi Okazaki, Zushi-shi (JP); Shoichi Narahashi, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NTT DoCoMo, Inc, Chiyoda-ku (JP)

(21) Appl. No.: 12/207,037

(22) Filed: Sep. 9, 2008

(30) Foreign Application Priority Data
Sep. 10, 2007 (JP) 2007-234099

(51) Int. Cl. H01P 1/10

(52) U.S. Cl. 333/101

(57) ABSTRACT

A signal selecting device according to the present invention has two input/output ports, a plurality of resonating parts, a plurality of impedance transforming parts, and a controlling part. The resonating parts have a ring conductor having a length equal to one wavelength at a resonant frequency or an integral multiple thereof and a plurality of switches each of which is connected to a different part of the ring conductor at one end and to a ground conductor at the other end. The controlling part controls the state of the switches. The resonating parts are disposed in series between the two input/output ports. The impedance transforming parts are disposed between the input/output ports in such a manner that the impedance transforming parts at the both ends are disposed between the input/output port and the resonating part and the remaining impedance transforming parts are disposed between the resonating parts.

### BACKGROUND OF THE INVENTION

The present invention relates to a signal selecting device used in transmission, reception or transmission/reception of information. In the field of radio communication using radio waves, necessary signals and unnecessary signal are separated by extracting signals at a particular frequency from a large number of signals. Filters that perform this function comprise a resonator and an impedance transforming circuit and are incorporated in many radio devices. Such filters cannot change design parameters, such as the center frequency and the bandwidth. Therefore, a radio communication device using a plurality of combinations of center frequencies and bandwidths has to have a number of filters equal to the number of combinations of center frequencies and bandwidths and select a filter for use by means of a switch or the like. For example, a non-patent literature 1 (DoCoMo Technical Journal Vol. 14, No. 2, pp. 31-37) discloses a related art in which a filter for use is selected from among a plurality of filters by means of a switch.

Related arts, such as that disclosed in the non-patent literature 1, have a problem that, as the number of combinations of center frequencies and bandwidths increases, the circuit area and the number of components also increase. An object of the present invention is to provide a filter capable of appropriately changing a center frequency and a bandwidth by controlling characteristics of a resonator and an impedance transforming circuit and to reduce the number of filters used even when a plurality of combinations of center frequencies and bandwidths is used.

### SUMMARY OF THE INVENTION

A signal selecting device according to the present invention has two input/output ports, a plurality of resonating parts, a plurality of impedance transforming parts, and a controlling part. The resonating parts have a ring conductor having a length equal to one wavelength at a resonant frequency or an integral multiple thereof and a plurality of switches each of which is connected to a different part of the ring conductor at one end and to a ground conductor at the other end. The controlling part controls the state of the switches. The resonating parts are disposed in series between the two input/output ports. The impedance transforming parts are disposed between the input/output ports in such a manner that the impedance transforming parts at the both ends are disposed between the input/output port and the resonating part and the remaining impedance transforming parts are disposed between the resonating parts. That is, the number of the impedance transforming parts is greater than the number of resonating parts by one. The impedance transforming parts adjust the impedance between the outside and the resonating parts or between the resonating parts. The term “ring conductor” means a conductor (a transmission line) having the opposite ends thereof connected to each other and is not limited to a particular shape. That is, the shape of the ring conductor is not limited to a circular shape, but the ring conductor can have any other shape, such as a polygonal shape.

The impedance transforming parts may be capable of changing the characteristics. In that case, the controlling part controls the characteristics of the impedance transforming parts. In particular, in a case where the signal selecting device has an odd number of resonating parts, all the impedance transforming parts can be configured to have the same characteristics at the operational frequency of the signal selecting device. Alternatively, in a case where the signal selecting device has an even number of resonating parts (it means that the number of the impedance transforming parts is an odd number), the impedance transforming part disposed at the center alone can be controlled to have characteristics different from those of the remaining impedance transforming parts.

Three or more variable reactance means can be connected to the ring conductor at regular intervals. In that case, the controlling part controls the characteristics of the variable reactance means.

One or more branch parts can be disposed between the impedance transforming parts and the resonating parts, and a switch part can be disposed between one of the input/output port and the impedance transforming parts. In that case, switching can be performed so that one of the branch parts is selected and is connected to the switch part.

### EFFECT OF THE INVENTION

According to the present invention, the resonating parts having the ring conductor and the switches can arbitrarily change the susceptance slope parameter highly independently of the resonant frequency. Therefore, the signal selecting device can be easily designed to have desired characteristics. In addition, the bandwidth and the in-band and out-band characteristics can also be changed by changing the susceptance slope parameter of the resonating parts.

Furthermore, in a case where the resonating parts have variable reactance means connected to the ring conductor at appropriate intervals, the signal selecting device can change the center frequency highly independently of the bandwidth and the in-band and out-band characteristics. In addition, in a case where the characteristics of the impedance transforming parts can be changed, the signal selecting device can more appropriately adjust the bandwidth and the in-band and out-band characteristics.

Furthermore, in a case where the signal selecting device has the branch parts and the switch part, the number of resonators can be changed. That is, the bandwidth and the in-band and out-band characteristics can be more flexibly adjusted.

### BRIEF DESCRIPTION OF THE DRAWINGS

FIG. 1 is a diagram showing an exemplary functional configuration of a signal selecting device according to an embodiment 1;

FIG. 2A is a diagram showing a configuration of a resonating part;

FIG. 2B is a diagram showing an equivalent circuit using a lossless transmission line model;

FIG. 3 is a graph showing a relationship between the susceptance slope parameter and θ in a single resonator;

FIG. 4 is a diagram showing a section of the signal selecting device that includes resonating parts and impedance transforming parts;

FIG. 5 is a diagram for explaining characteristics of a typical J-inverter;

FIG. 6 is a diagram showing an exemplary functional configuration of a signal selecting device according to an embodiment 2;

FIG. 7 is a graph showing frequency characteristics of the signal selecting device grounded at determined positions;

FIG. 8 is a diagram showing an exemplary functional configuration of a signal selecting device according to an embodiment 3;

FIG. 9 is a diagram showing a section of the signal selecting device having four resonating parts and five impedance transforming parts that includes the resonating parts and the impedance transforming parts;

FIG. 10 is a diagram showing an exemplary functional configuration of a signal selecting device according to an embodiment 4;

FIG. 11 is a diagram showing an exemplary configuration in which arrangement of variable reactance means is modified;

FIG. 12 is a diagram showing an exemplary functional configuration of a signal selecting device according to an embodiment 5;

FIG. 13 is a diagram showing an exemplary functional configuration of a signal selecting device according to an embodiment 6;

FIG. 14 is a diagram showing an exemplary functional configuration of a signal selecting device according to an embodiment 7;

FIG. 15 is a diagram showing an exemplary functional configuration of a signal selecting device according to an embodiment 8;

FIG. 16A is a diagram showing an example of the impedance transforming part that is formed by a transmission line having a characteristic impedance of Z and a length equal to a quarter wavelength at a resonant frequency;

FIG. 16B is a diagram showing an example of the impedance transforming part that is formed by a capacitor;

FIG. 16C is a diagram showing an example of the impedance transforming part that is formed by a coil;

FIG. 16D is a diagram showing an example of the impedance transforming part that is formed by lines coupled by electromagnetic induction;

FIG. 16E is a diagram showing an example of the impedance transforming part that is formed by a combination of the examples shown in FIGS. 16A to 16D;

FIG. 17A is a diagram showing an example of an impedance transforming part capable of changing the characteristics that is formed by a transmission line having a characteristic impedance of Z and a length equal to a quarter wavelength at a resonant frequency and variable capacitors connected in parallel to the transmission line;

FIG. 17B is a diagram showing an example of the impedance transforming part capable of changing the characteristics that is formed by a variable capacitor;

FIG. 17C is a diagram showing an example of the impedance transforming part capable of changing the characteristics that is formed by a variable coil;

FIG. 17D is a diagram showing an example of the impedance transforming part capable of changing the characteristics that is formed by lines variably electromagnetically coupled to each other;

FIG. 17E is a diagram showing an example of the impedance transforming part capable of changing the characteristics that is formed by two kinds of transmission lines that have a length equal to a quarter wavelength at a resonant frequency and different characteristic impedances and are switched from one to another;

FIG. 17F is a diagram showing an example of the impedance transforming part capable of changing the characteristics that is formed by two kinds of transmission lines that have a length equal to a quarter wavelength at different resonant frequencies and the same characteristic impedance and are switched from one to another;

FIG. 18A is an example in which a switch that makes a short circuit is used as a switch when ring conductors are connected in series to a signal line;

FIG. 18B is an example in which a switch that makes a short circuit via a transmission line is used as a switch when ring conductors are connected in series to a signal line;

FIG. 18C is an example in which a switch that establishes a connection of a transmission line having an open end is used as a switch when ring conductors are connected in series to a signal line;

FIG. 19A is a diagram showing an exemplary functional configuration of a controlling part according to the embodiments 1, 2 and 8;

FIG. 19B is a diagram showing an exemplary functional configuration of a controlling part according to the embodiment 3;

FIG. 19C is a diagram showing an exemplary functional configuration of a controlling part according to the embodiment 4;

FIG. 20A is a diagram showing another exemplary functional configuration of the controlling part according to the embodiments 1 and 2;

FIG. 20B is a diagram showing another exemplary functional configuration of the controlling part according to the embodiment 3;

FIG. 20C is a diagram showing another exemplary functional configuration of the controlling part according to the embodiment 4;

FIG. 21A is an example of processing means that is composed of a calculation unit, a storage unit and a control unit; and

FIG. 21B is an example of the processing means that is composed of a retrieval unit, a storage unit and a control unit.

### DETAILED DESCRIPTION OF THE PREFERRED EMBODIMENTS

### Embodiment 1

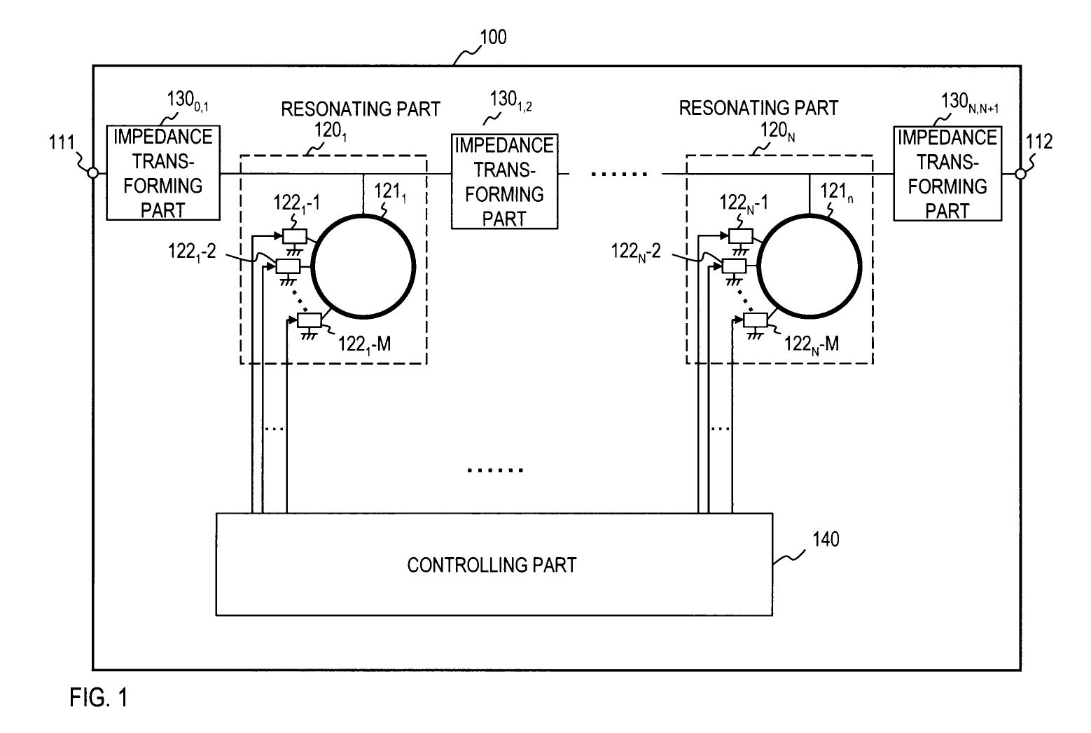

FIG. 1 is a diagram showing an exemplary functional configuration of a signal selecting device according to an embodiment 1. A signal selecting device 100 has two input/output ports 111 and 112, N resonating parts 120₁ to 120_{N}, N+1 impedance transforming parts 130_{0,1} to 130_{N,N+1}, and a controlling part 140. The resonating part 120ₙ (n represents any integer in a possible range and is an integer from 1 to N in this case) has a ring conductor 121ₙ having a length equal to one wavelength at a resonant frequency or an integral multiple thereof, and M switches 122ₙ-1 to 122ₙ-M each of which is connected to a different part of the ring conductor 121ₙ at one end thereof and to a ground conductor at the other end thereof. The controlling part 140 controls the state of the N*M switches 122₁-1 to 122_{N}-M. (“N*M” shows multiplying N by M.) The resonating parts 120₁ to 120_{N} are disposed in series between the two input/output ports. The impedance transforming parts 130_{0,1} to 130_{N,N+1} are disposed between the input/output ports in such a manner that the impedance transforming parts 130_{0,1} and 130_{N,N+1} at the both ends are disposed between the input/output port and the resonating part and the remaining impedance transforming parts 130_{1,2} to 130_{N-1,N} are disposed between the resonating parts. Specifically, the impedance transforming part 130_{n,n+1} (n represents any integer in a possible range as described above and is an integer from 1 to N−1 in this case) is disposed between the resonating part 120ₙ and the resonating part 120ₙ₊₁ and adjusts the impedance between the resonating parts 120ₙ and the resonating part 120ₙ₊₁. The impedance transforming part 130_{0,1} changes the impedance between the outside on the input/output port 111 and the resonating part 120₁. The impedance transforming part 130_{N,N+1} changes the impedance between the resonating part 120ₙ and the outside on the input/output port 112. The ring conductor 121ₙ means a conductor (a transmission line) having the opposite ends thereof connected to each other and is not limited to a particular shape. That is, while the ring conductor has a circular shape in FIG. 1, the ring conductor can have a polygonal or other shape instead of the circular shape.

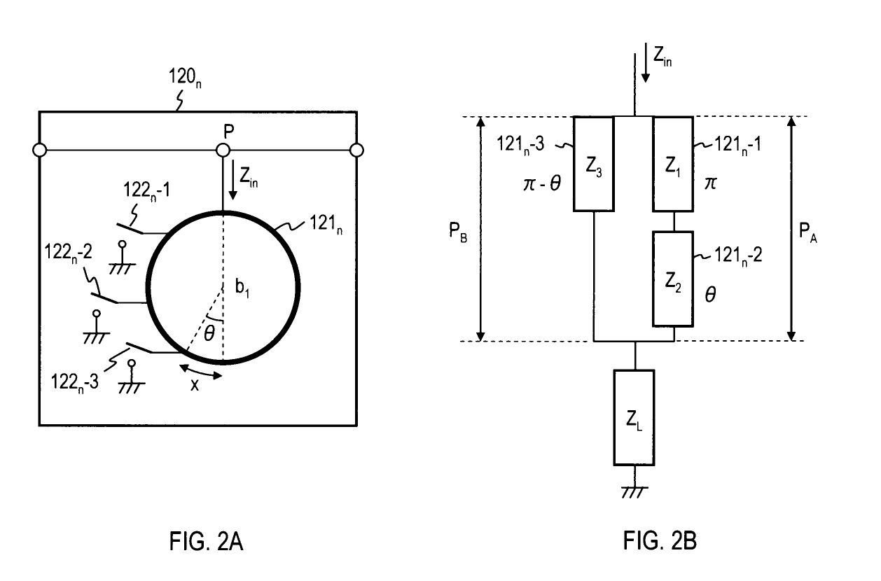

FIG. 2A shows a configuration of the resonating part 120ₙ. FIG. 2B shows an equivalent circuit using a lossless transmission line model. Zᵢₙ denotes the input impedance of the resonating part 120ₙ from the point P. An operation of the resonating part 120ₙ will be described by determining the input impedance Zᵢₙ of the model shown in FIG. 2B in a case where the switch 122ₙ-3 shown in FIG. 2A is in the on state. At a resonant frequency fᵣ, a transmission line 121ₙ-1 has an electrical length of π and a characteristic impedance of Z₁, a transmission line 121ₙ-2 has an electrical length of θ and a characteristic impedance of Z₂, and a transmission line 121ₙ-3 has an electrical length of (π-θ) and a characteristic impedance of Z₃. That is, the total sum of the electrical lengths of the transmission lines 121ₙ-1, 121ₙ-2 and 121ₙ-3 is 2π (360 degrees). A path P_{A} composed of the transmission line 121ₙ-1 and the transmission line 121ₙ-2 is a path extending clockwise from the point P to the switch 122ₙ-3 in FIG. 2A. A path P_{B} composed of the transmission line 121ₙ-3 is a path extending counterclockwise from the point P to the switch 122ₙ-3 in FIG. 2A. Z_{L} denotes the impedance between the switch 122ₙ-3 to the ground.

In this case, the input impedance Zᵢₙ is expressed by the following formula (1). In this formula, j denotes an imaginary unit.

$${Z}_{in} = \frac{{y}_{22} + {Y}_{L}}{{y}_{11} ( {y}_{22} + {Y}_{L} ) - {y}_{12} {y}_{21}} \qquad ( 1 )$$

In this formula,

y₁₁=−jY₂ cot θ+jY₃ cot θ

y₁₂=−jY₂ cot θ+jY₃ cot θ

y₂₁=−jY₂ cot θ+jY₃ cot θ

y₂₂=−jY₂ cot θ+jY₃ cot θ

Y₂=1/Z₂,Y₃=1/Z₃,Y_{L}=1/Z_{L}

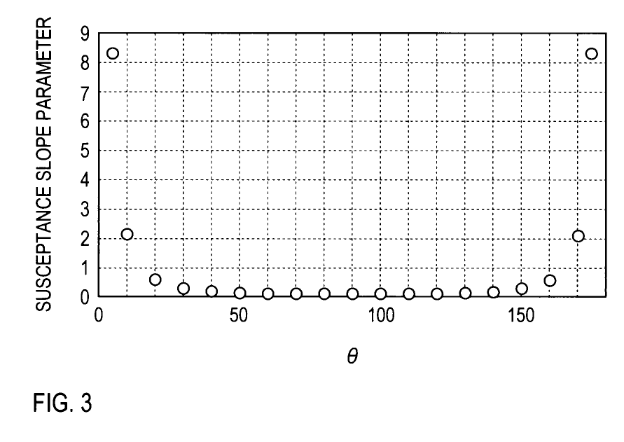

, where L denotes the length of the ring conductor, and θ=x/2π(rad). As can be seen from the formula (1), when Y₂=Y₃, the impedance Zᵢₙ is infinity except when θ is 0 or an integral multiple of π. When θ is 0 or an integral multiple of π, Zᵢₙ=Z_{L}. That is, when the line length (physical length)×changes, the resonant frequency is constant except when the line length reduced to an electrical length at the resonant frequency is 0 or an integral multiple of π. Next, FIG. 3 shows a relationship between θ and the susceptance slope parameter in a single resonator in a case where the impedances Z₁, Z₂ and Z₃ are 50Ω. The susceptance slope parameter b is determined by the following formula.

$$b = \frac{{ω}_{0}}{2} \frac{d B}{d ω} {\vert}_{{ω}_{0}} , \qquad ( 2 )$$

, where B=Im (Yᵢₙ), and Yᵢₙ=1/Zᵢₙ.
From this drawing, it can be seen that the susceptance slope parameter b can be changed without changing the resonant frequency by changing the value θ, or in other words, changing the switch to be turned on. In addition, as can be seen from the formula (2), the susceptance slope parameter b indicates the variation of the imaginary part of the admittance with respect to the frequency. As the susceptance slope parameter b becomes greater, the admittance changes more greatly with respect to the difference frequency with respect to the resonant frequency. Therefore, in a band-pass filter using parallel resonance, for example, the bandwidth becomes narrower. As described later, the in-band and out-band characteristics are determined by the susceptance slope parameter b. That is, the bandwidth and the in-band and out-band characteristics can be changed by the resonating part, and the bandwidth can be changed by changing the susceptance slope parameter b while keeping the center frequency constant.

A principle of changing the bandwidth and the in-band and out-band characteristics of the filter has been described above. Actually, in order to change the bandwidth and the in-band and out-band characteristics of the filter, an appropriate switch 122ₙ-m (m represents any integer in a possible range and is an integer from 1 to M in this case) to be turned on has to be selected from among the large number of switches. In the signal selecting device 100 shown in FIG. 1, the controlling part 140 selects the switch 122ₙ-m to be turned on. In order for the controlling part 140 to select the appropriate switch 122ₙ-m, the controlling part 140 has to consider the relationship between the position of the switch 122ₙ-m to be turned on and the susceptance slope parameter b of the resonating part 120ₙ and the relationship between the susceptance slope parameter b and the characteristics of the signal selecting device 100. The relationship between the position of the switch 122ₙ-m and the susceptance slope parameter b has already been described with reference to FIG. 3. In the following, the relationship between the susceptance slope parameter b and the characteristics of the signal selecting device 100 will be described.

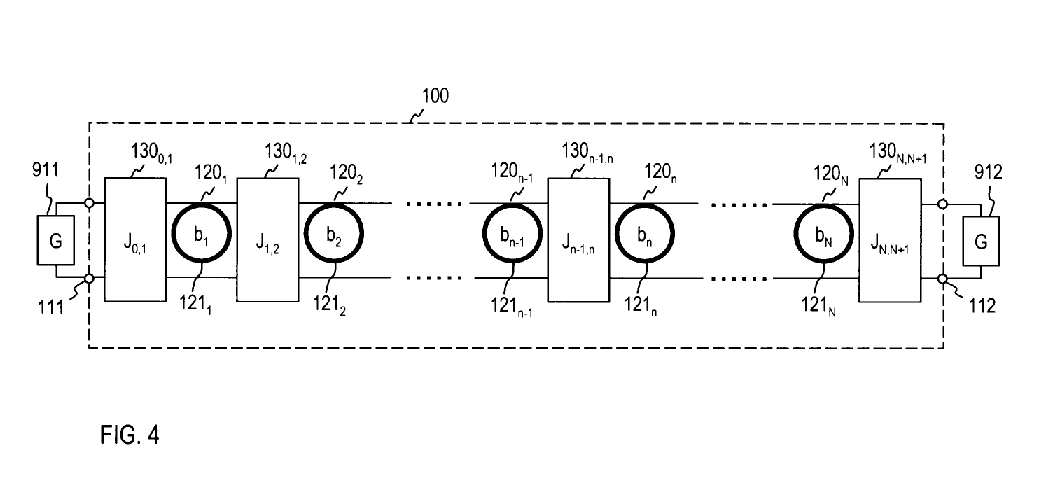

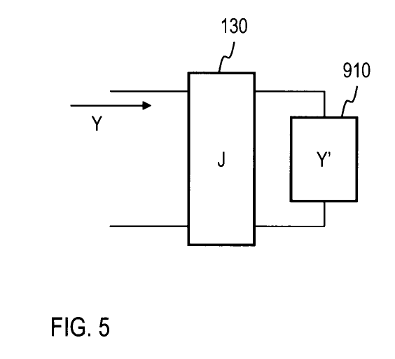

FIG. 4 is a diagram showing a section of the signal selecting device shown in FIG. 1 that includes the resonating parts and the impedance transforming parts. There are N resonating parts 120₁ to 120_{N} and N+1 impedance transforming parts 130_{0,1} to 130_{N,N+1}. The impedance transforming parts 130_{0,1} to 130_{N,N+1} are disposed between the input/output ports 111 and 112 in such a manner that the impedance transforming part 130_{0,1} is disposed between the input/output port 111 and the resonating part 120₁, the impedance transforming part 130_{N,N+1} is disposed between the input/output port 112 and the resonating part 120_{N}, and the remaining impedance transforming parts 130_{1,2} to 130_{N-1,N} are disposed between the remaining resonating parts. Admittance 911 and 912 are port admittances of the input/output ports 111 and 112, respectively. The impedance transforming parts 130_{0,1} to 130_{N,N+1} transform the impedance of a component connected thereto (a circuit or an element, for example) to an impedance that is proportional to the inverse thereof. The ring conductor 121 of the resonating part 120ₙ used in the signal selecting device 100 is connected in parallel with a transmission line that connects the impedance transforming part 130_{n-1, n} and the impedance transforming part 130_{n,n+1}. The impedance transforming parts 130_{0,1} to 130_{N,N+1} in this case are referred to as admittance inverter or J-inverter. FIG. 5 is a diagram for explaining the characteristics of a typical J-inverter. The characteristics of the J-inverter shown in this drawing is expressed by the following formula.

$$Y = \frac{{J}^{2}}{{Y}^{′}} \qquad ( 3 )$$

That is, the admittance parameter J of the J-inverter is a coefficient that determines the number by which the admittance inverted by the J-inverter is multiplied.

The admittance parameter J_{n-1,n} of the impedance transforming part 130_{n-1, n} are expressed by the following formulas using the bandwidth (fractional bandwidth), the in-band and the out-band characteristics.

$$\begin{matrix}{J}_{0 , 1} = \sqrt{\frac{{Gb}_{1} w}{{g}_{0} {g}_{1}}} & ( 4 ) \\ {J}_{n - 1 , n} = w \sqrt{\frac{{b}_{n - 1} {b}_{n}}{{g}_{n - 1} {g}_{n}}} & ( 5 ) \\ {J}_{N , N + 1} = \sqrt{\frac{{Gb}_{N} w}{{g}_{N} {g}_{N + 1}}} & ( 6 )\end{matrix}$$

In these formulas, G denotes the port admittance, and bₙ denotes the susceptance slope parameter of the n-th resonating part 120ₙ. w denotes the fractional bandwidth of the signal selecting device 100, gₙ denotes an element value of an original low pass filter, and these values determine the bandwidth and the in-band and out-band characteristics of the signal selecting device 100. When these parameters satisfy the relationships expressed by the formulas (4) to (6), the signal selecting device 100 has desired characteristics. Of these parameters, the fractional bandwidth w and the element value gₙ of the original low pass filter are determined from the characteristics of the signal selecting device 100 to be achieved. The port admittance G depends on the circuits preceding and following the signal selecting device 100. Therefore, the admittance parameter J_{n-1, n} or the susceptance slope parameter bₙ can be adjusted to satisfy the relationship expressed by the formulas (4) to (6).

Conventional signal selecting devices (filters) cannot arbitrarily change the susceptance slope parameter bₙ. Therefore, after the fractional bandwidth w and the element value gₙ of the original low pass filter are determined, the admittance parameter J_{n-1,n} that satisfies the formulas (4) to (6) has to be designed with the susceptance slope parameter bₙ being fixed. In addition, conventionally, a capacitor is often used as the J-inverter. However, if the bandwidth is changed by changing the capacitance of the capacitor, the operational frequency of the J-inverter also changes. That is, the center frequency also changes. Therefore, it is difficult to design the J-inverter that satisfies the formulas (4) to (6).

To the contrary, the signal selecting device 100 according to the present invention has the resonating part 120ₙ incorporating the ring conductor 121ₙ and therefore can arbitrarily change the susceptance slope parameter bₙ. That is, the characteristics of the signal selecting device 100 can be changed by changing the susceptance slope parameter bₙ of the resonating part 120ₙ. Therefore, in case of designing of the signal selecting device 100, the fractional bandwidth w and the element value gₙ of the original low pass filter are determined and the admittance parameter J_{n-1,n} is calculated from the characteristics of the circuit of the impedance transforming part 130_{n-1,n} (J-inverter). Then, the switch to be turned on can be selected among the switches 122ₙ-1 to 122ₙ-M so that the susceptance slope parameter bₙ satisfies the formulas (4) to (6). That is, the condition that the formulas (4) to (6) have to be satisfied does not have to be considered in design of the J-inverter, so that the J-inverter can be easily designed.

Furthermore, when the bandwidth and the in-band and out-band characteristics are to be changed, the switch 122₁-1 to 122_{N}-M to be turned on can be changed to meet the desired characteristics. In this case, the resonant frequency of the resonating part 120ₙ does not change, and the admittance parameter J_{n-1,n} also does not change, so that the center frequency can be kept constant. In actual, the number of switches is finite, so that the possible susceptance slope parameters bₙ are discrete. Therefore, a switch 122₁-1 to 122_{N}-M that provides a value closest to the required susceptance slope parameter bₙ is selected.

As described above, in a signal selecting device according to the embodiment 1, the resonating part having the ring conductor and the switches can arbitrarily change the susceptance slope parameter highly independently of the resonant frequency. Therefore, the signal selecting device can be easily designed to have desired characteristics. In addition, the bandwidth and the characteristics can be changed by changing the susceptance slope parameter of the resonating part.

### Embodiment 2

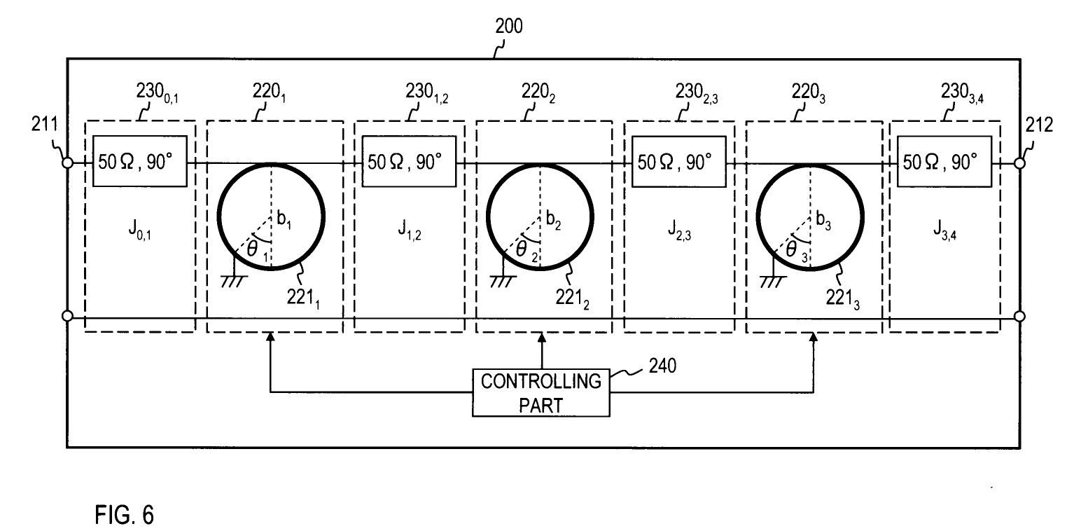

In the embodiment 1, a signal selecting device according to the present invention has been generally described. In an embodiment 2, a signal selecting device according to the present invention will be specifically described. FIG. 6 is a diagram showing an exemplary functional configuration of a signal selecting device according to the embodiment 2. A signal selecting device 200 has input/output ports 211 and 212, three resonating parts 220₁ to 220₃, four impedance transforming parts 230_{0,1} to 230_{3,4}, and a controlling part 240. The resonating part 220ₙ has a ring conductor 221ₙ. Although not shown in FIG. 6, the resonating part 220ₙ has switches as in the embodiment 1. The input/output ports 211 and 212 have a port impedance of 50Ω. The resonating part 220ₙ has a resonant frequency of 5 GHz, and the ring conductor 221ₙ has a characteristic impedance of 50Ω. For the convenience of explanation, it is assumed that the position of grounding of the resonator is changed instead of selecting the switch to be turned on. The positions of the switches are shown by θ₁ to θ₃ in the drawing. The impedance transforming parts 230_{0,1} to 230_{3,4} are transmission lines, which have a characteristic impedance of 50Ω and a length equal to a quarter of the wavelength at 5 GHz. At this time, the admittance parameter of the impedance transforming parts 230_{0,1} to 230_{3,4} is 0.02 S. In addition, since the port impedance is 50Ω, the port admittance is 0.02 S.

Next, there will be specifically described a way of changing the positions θ₁ to θ₃ of the switches when the characteristics to be achieved of the signal selecting device 200 is changed. For example, there will be considered three cases where the characteristics to be achieved of the signal selecting device 200 are Butterworth characteristics with a fractional bandwidth of 3%, Butterworth characteristics with a fractional bandwidth of 5%, and Chebyshev characteristics (with a ripple of 0.1 dB) with a fractional bandwidth of 3%. In any of the cases, the center frequency is supposed to be 5 GHz.

First, two cases where the signal selecting device has Butterworth characteristics will be considered. In the case of the Butterworth characteristics, the element values g₀ to g₄ of the original low pass filters of the three resonating part 220₁ to 220₃ are 1, 1, 2, 1 and 1, respectively. For the cases where the fractional bandwidth is 0.03 (3%) and 0.05 (5%), the susceptance slope parameters b₁ to b₃ are determined using the formulas (4) to (6). Then, in the case where the fractional bandwidth is 3%, b₁=0.67, b₂=1.33, and b₃=0.67. In the case where the fractional bandwidth is 5%, b₁=0.4, b₂=0.8, and b₃=0.4. Then, the grounding positions θ₁ to θ₃ that provide these values are determined. The susceptance slope parameters b₁ to b₃ and the grounding positions θ₁ to θ₃ are shown by the formula (2) and in FIG. 3. The grounding positions θ₁ to θ₃ determined using FIG. 3 are about 18 degrees, 13 degrees and 18 degrees, respectively, in the case where the fractional bandwidth is 3%, and about 23 degrees, 16 degrees and 23 degrees, respectively, in the case where the fractional bandwidth is 5%.

Next, the case where the signal selecting device has Chebyshev characteristics, and the fractional bandwidth to be achieved is 3% will be considered. In the case of the Chebyshev characteristics with a ripple of 0.1 dB, the element values g₀ to g₄ of the original low pass filters of the three resonating part 220₁ to 220₃ are 1, 1.0315, 1.1474, 1.0315 and 1, respectively. Based on the fractional bandwidth of 0.03 (3%), the susceptance slope parameters b₁ to b₃ are determined using the formulas (4) to (6). Then, b₁=0.69, b₂=0.76, and b₃=0.69. From FIG. 3, the grounding positions θ₁ to θ₃ that provide these susceptance slope parameters determined from FIG. 3 are about 17 degrees, 17 degrees and 17 degrees, respectively.

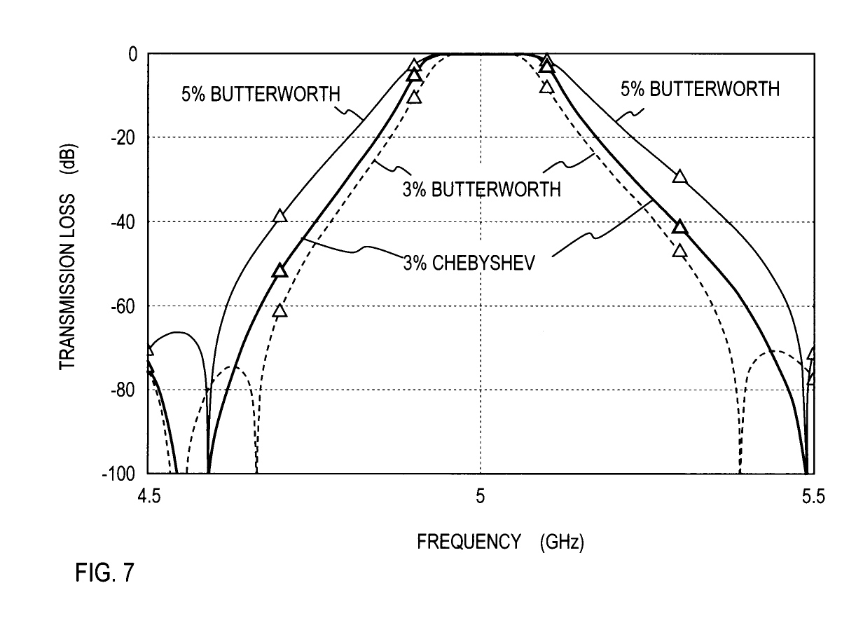

FIG. 7 shows frequency characteristics of the signal selecting device 200 grounded at the positions determined as described above. In this way, switching among the Butterworth characteristics with the fractional bandwidth of 3%, the Butterworth characteristics with the fractional bandwidth of 5% and the Chebyshev characteristics (with a ripple of 0.1 dB) with the fractional bandwidth of 3% can be achieved by changing the grounding positions. That is, it can be seen that the in-band and out-band characteristics can be changed by selecting the switch to be turned on. The grounding positions can also be determined in an analytical manner instead of using a graph as in this embodiment.

### Embodiment 3

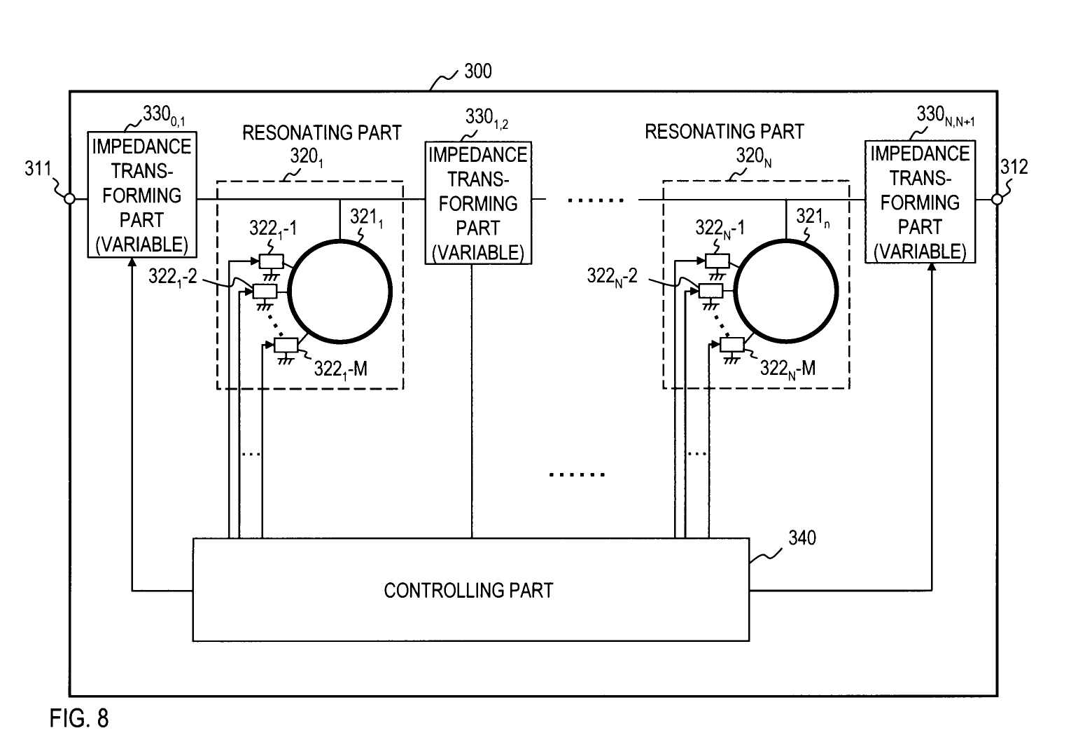

In the embodiment 2, all the impedance transforming parts have the same, fixed characteristics. If such identical impedance transforming parts are used in this way, the signal selecting device can be easily designed and fabricated. However, the impedance transforming parts do not always have to have the same characteristics but can have different characteristics or variable characteristics. FIG. 8 is a diagram showing an exemplary functional configuration of a signal selecting device according to an embodiment 3. A signal selecting device 300 has two input/output ports 311 and 312, N resonating parts 320₁ to 320_{N}, N+1 impedance transforming parts 330_{0,1} to 230_{N,N+1} capable of changing the characteristics, and a controlling part 340. While all the impedance transforming parts 330_{0,1} to 330_{N,N+11} are shown as being capable of changing the characteristics in FIG. 8, only one particular impedance transforming part may be capable of changing the characteristics. The resonating part 320ₙ has a ring conductor 321ₙ having a length equal to one wavelength at a resonant frequency or an integral multiple thereof, and M switches 322ₙ-1 to 322ₙ-M each of which is connected to a different part of the ring conductor 321ₙ at one end thereof and to a ground conductor at the other end thereof. The controlling part 340 controls the state of the N*M switches 322₁₋₁ to 322_{N}-M and the characteristics of the impedance transforming parts 330_{0,1} to 330_{N,N+1}. The resonating parts 320₁ to 320_{N} are disposed in series between the two input/output ports. The impedance transforming parts 330_{0,1} to 330_{N,N+1} are disposed between the input/output ports in such a manner that the impedance transforming parts 130_{0,1} and 130_{N,N+1} at the both ends are disposed between the input/output port and the resonating part and the remaining impedance transforming parts 130_{1,2} to 130_{N-1,N} are disposed between the resonating parts. The configuration shown in FIG. 8 has a high design flexibility and facilitate achievement of desired filter characteristics. In the two examples described below, the impedance transforming parts 330_{0,1} to 330_{N,N+1} (J-inverters) need to have variable characteristics.

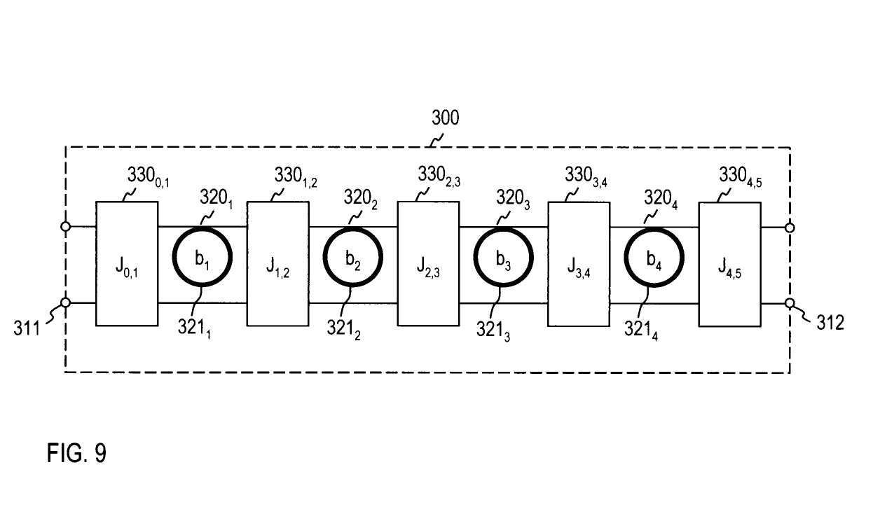

One example is a case where an even number of resonating parts are used. In this specification, a signal selecting device using four resonating parts and five impedance transforming parts will be described. FIG. 9 shows a section of the signal selecting device 300 shown in FIG. 8 having four resonating parts and five impedance transforming parts that includes the resonating parts and the impedance transforming parts. For example, the signal selecting device 300 having four resonating parts 320₁ to 320₄ is designed to have Chebyshev characteristics with a center frequency of 5 GHz, a fractional bandwidth of 5% and a ripple of 0.1 dB. The element value g₀ to g₅ of the original low pass filters are 1, 1.1088, 1.3061, 1.77.3, 0.8180 and 1.3554, respectively. The fractional bandwidth is 0.05. In the embodiment 2, each susceptance slope parameter bₙ is determined on the assumption that the admittance parameter is 0.02 S because all the impedance transforming parts (J-inverters) are quarter-wave transmission lines having a characteristic impedance of 50Ω. However, in the case of the signal selecting device having four resonating parts, the solutions that satisfy the formulas (4) to (6) cannot be found if the same admittance parameter is substituted in the formulas. This is because the element values gₙ of the original low pass filters are not symmetrical if there are an even number of stages of components having Chebyshev characteristics. In other words, the sequence of the element values gₙ of the original low pass filters viewed from the leading end differs from the sequence of the same element values gₙ viewed from the trailing end. Thus, in order to satisfy all the relationships expressed by the formulas (4) to (6), the admittance parameter of at least one impedance transforming part has to be different from that of the other impedance transforming parts. In the case of the Butterworth characteristics, the sequence of the element values of the original low pass filters is always symmetrical, and therefore, all the impedance transforming parts can have the same admittance parameter.

That is, in order for the signal selecting device having an even number of resonating parts to switch between the Chebyshev characteristics and Butterworth characteristics, at least one impedance transforming part has to be variable. Any of the impedance transforming parts can be variable. However, the central impedance transforming part is preferably variable because the central impedance transforming part can change the filter characteristics widely. The reason for this will be described in detail with reference to FIG. 9. First, in the case where the impedance transforming part 330_{4,5} closest to the input/output port is variable, to achieve Chebyshev characteristics with a fractional bandwidth of 5% and a ripple of 0.1 dB, the admittance parameter is 0.017, and the susceptance slope parameters b₁ to b₄ are 0.444, 0.522, 0.708 and 0.327, respectively. Next, in the case where the impedance transforming part 330_{3,4} next closest to the input/output port is variable, the admittance parameter is 0.023, and the susceptance slope parameters b₁ to b₄ are 0.444, 0.522, 0.708 and 0.443, respectively. In the case where the central impedance transforming part 330_{2,3} is variable, the admittance parameter is 0.017, and the susceptance slope parameters b₁ to b₄ are 0.444, 0.522, 0.522 and 0.443, respectively. As can be seen, the susceptance slope parameters b₁ to b₄ in the case where the central impedance transforming part 330_{2,3} is variable are less variable than the susceptance slope parameters b₁ to b₄ in the cases where the impedance transforming part 330_{4,5} is variable and where the impedance transforming part 330_{3,4} is variable. The susceptance slope parameters b₁ to b₄ of the resonating parts 320₁ to 320₄ vary with the grounding position and reach a maximum value when θ is 90 degrees. However, the value depends on the characteristic impedances of the ring-shaped lines forming the respective resonating part, and therefore, if the resonating part is formed by a line having a fixed characteristic impedance, the maximum value is set during design and cannot be changed. As the variation of the susceptance slope parameters b₁ to b₄ becomes smaller, the range to which the resonating parts can be applied becomes wider. Thus, when the central impedance transforming part 330_{2,3} is variable, the range of the filter characteristics variation is widest.

As described above, in addition to achieving the same effect as a signal selecting device according to the embodiment 1, the signal selecting device according to the embodiment 3 can increase the design flexibility and enable switching between Chebyshev characteristics and Butterworth characteristics in case of the signal selecting device having an even number of resonating parts.

### Embodiment 4

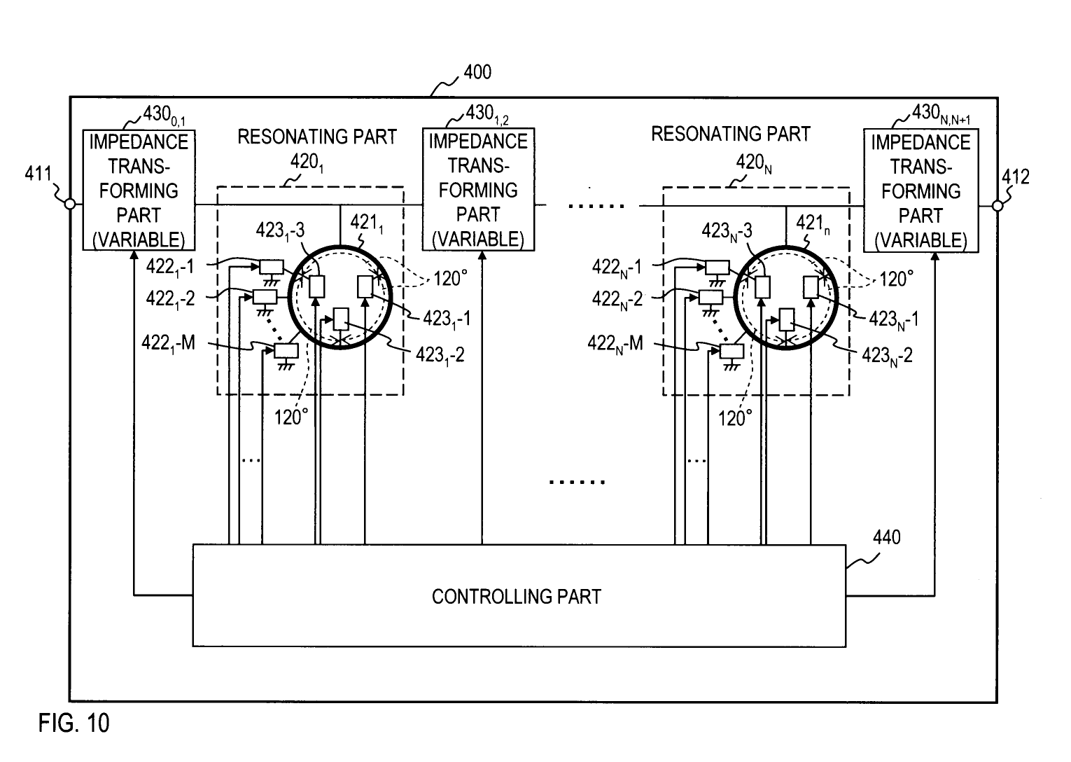

In the embodiment 3, one of the cases where the impedance transforming parts need to have variable characteristics has been described. In this embodiment 4, the other of the cases will be described. FIG. 10 is a diagram showing an exemplary functional configuration of a signal selecting device according to the embodiment 4. A signal selecting device 400 has two input/output ports 411 and 412, N resonating parts 420₁ to 420_{N}, N+1 impedance transforming parts 430_{0,1} to 430_{N,N+1} capable of changing the characteristics, and a controlling part 440. The resonating part 420ₙ has a ring conductor 421ₙ having a length equal to one wavelength at a resonant frequency or an integral multiple thereof, M switches 422ₙ-1 to 422ₙ-M each of which is connected to a different part of the ring conductor 421ₙ at one end thereof and to a ground conductor at the other end thereof, and three variable reactance means 423ₙ-1 to 423ₙ-3 connected to the ring conductor 421ₙ at regular intervals. The controlling part 440 controls the state of the N*M switches 422₁-1 to 422_{N}-M, the characteristics of the impedance transforming parts 430_{0,1} to 430_{N,N+1} and the characteristics of the variable reactance means 423₁-1 to 423_{N}-3. The resonating parts 420₁ to 420_{N} are disposed in series between the two input/output ports. The impedance transforming parts 430_{0,1} to 430_{N,N+1} are disposed between the input/output ports in such a manner that the impedance transforming parts 430_{0,1} and 430_{N,N+1} at the both ends are disposed between the input/output port and the resonating part and the remaining impedance transforming parts 430_{1,2} to 430_{N-1,N} are disposed between the resonating parts. In this embodiment, if the ring conductors 421ₙ have the same characteristic impedance, the signal selecting device can be easily designed.

The resonating part 420ₙ of the signal selecting device 400 has three variable reactance means 423ₙ-1 to 423ₙ-3 connected to the ring conductor 421ₙ at regular intervals. Therefore, the signal selecting device 400 can change the resonant frequency and the zero point highly independently. To change the resonant frequency, the impedance has to be appropriately changed at the respective resonant frequencies, so that the impedance transforming parts 430_{0,1} to 430_{N,N+1} also have to be variable.

As described above, since each resonating part has the variable reactance means connected to the ring conductor at appropriate intervals, the center frequency can be changed highly independently of the bandwidth and the in-band and out-band characteristics. Furthermore, the variable impedance transforming circuits allows appropriate adjustment of the bandwidth and the in-band and out-band characteristics.

While the signal selecting device has been described as having three variable reactance means in this embodiment, the same effect can be achieved if the signal selecting device has four or more variable reactance means.

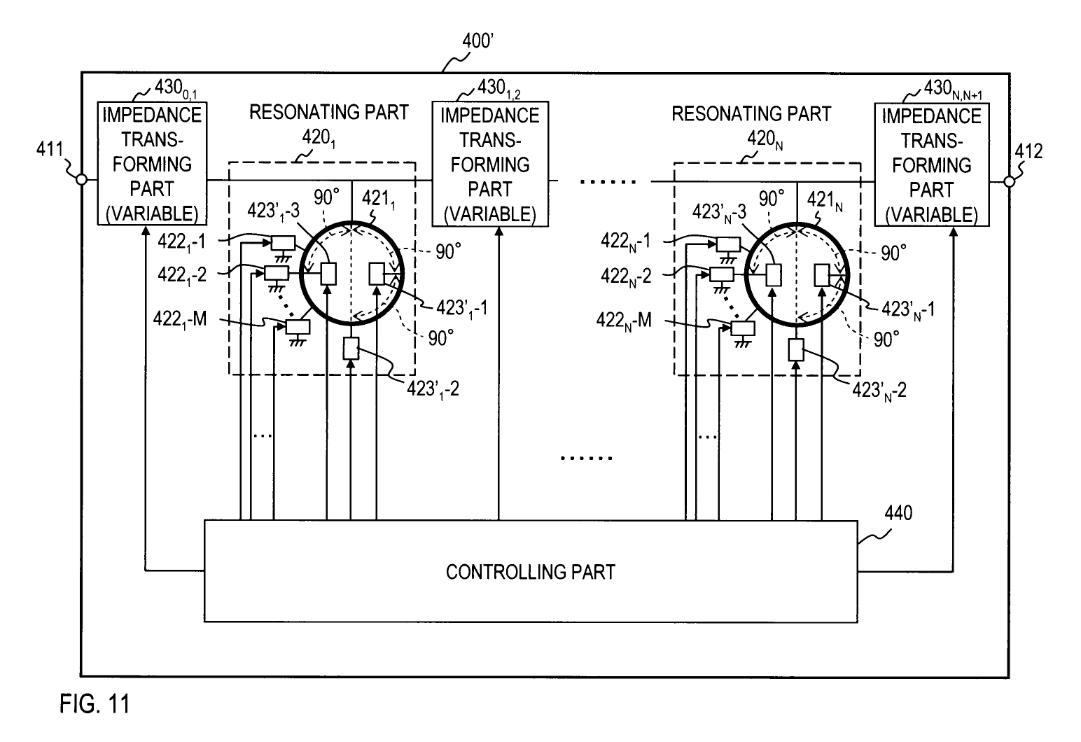

FIG. 11 shows a modified configuration of the signal selecting device shown in FIG. 10 in which the variable reactance means are not disposed at regular intervals. With the configuration shown in FIG. 11, the center frequency, the bandwidth and the in-band and out-band frequency characteristics can be changed by appropriately designing the positions of the variable reactance means and the reactances thereof. For example, in the case of a signal selecting device 400′, the reactance of the variable reactance means 423ₙ-2 can be set at a half the value of the variable reactance means 423ₙ-1 and 423ₙ-3. In this way, even if the arrangement of the variable reactance means changes, the same effect as that of the signal selecting device 400 can be achieved. In addition, the number of the variable reactance means of the signal selecting device 400′ is not limited to three, and the same effect can be achieved if the signal selecting device 400′ have four or more variable reactance means.

### Embodiment 5

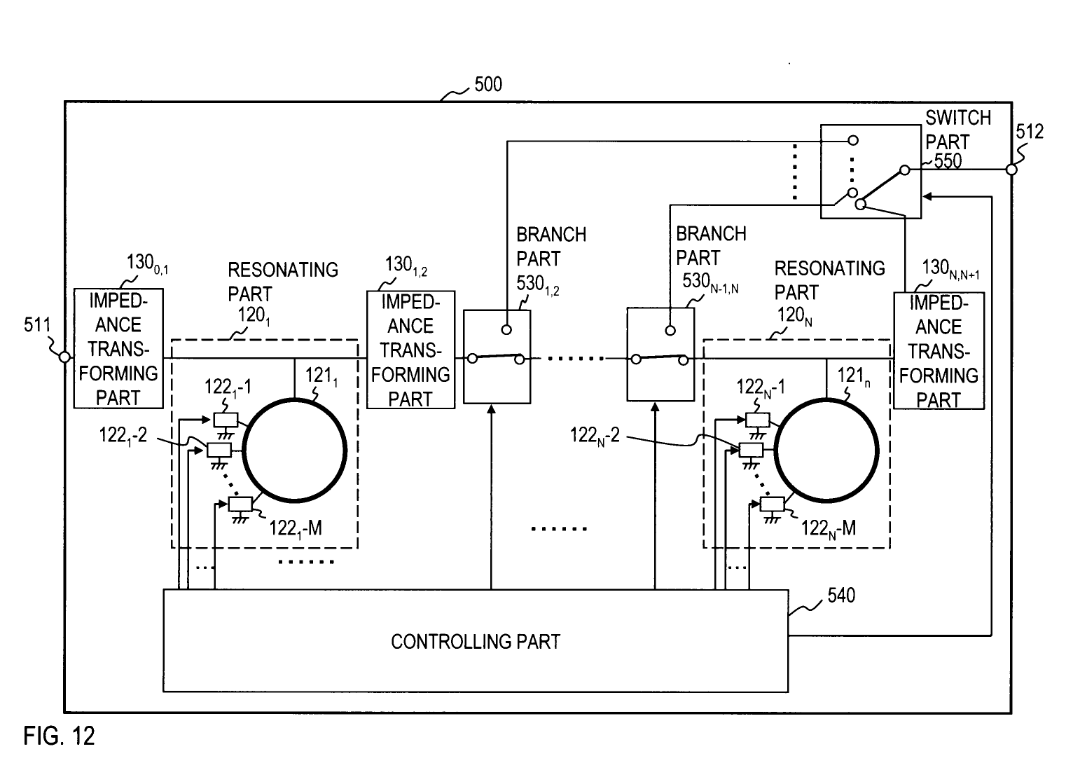

FIG. 12 is a diagram showing an exemplary functional configuration of a signal selecting device according to an embodiment 5. A signal selecting device 500 has the configuration of the signal selecting device 100 according to the embodiment 1 additionally provided with N−1 branch parts and a switch part. Specifically, a signal selecting device 500 has two input/output ports 511 and 512, N resonating parts 120₁ to 120_{N}, N+1 impedance transforming parts 130_{0,1} to 130_{N,N+1}, a controlling part 540, N−1 branch parts 530_{1,2} to 530_{N-1, N}, and a switch part 550. The branch part 530_{n,n+1} has three terminals and switches the state of connection between a predetermined terminal (one terminal) and the remaining terminals (two terminals). The switch part 550 has N+1 terminals and switches the state of connection between a predetermined terminal (one terminal) and the remaining terminals (N terminals). The predetermined terminal of the switch part 550 is connected to the input/output port 512, and one of the remaining terminals is connected to the impedance transforming part 130_{N,N+1} (or, in other words, disposed between the input/output port 512 and the impedance transforming part 130_{N,N+1}). The predetermined terminal of the branch part 530_{n,n+1} is connected to the impedance transforming part 130_{n,n+1} (on the side of the input/output port 511), and one of the remaining terminals is connected to the resonating part 120ₙ₊₁ (or, in other words, disposed between the impedance transforming part 130_{n,n+1} and the resonating part 120ₙ₊₁). The other of the remaining terminals of the branch part 530_{n,n+1} is connected to one of the remaining terminals of the switch part 550. The controlling part 540 controls the state of the N*M switches 122₁-1 to 122_{N}-M, the state of connection of the branch parts 530_{1,2} to 530_{N-1,N} and the state of connection of the switch part 550.

For example, in the case where all the branch parts 530_{n,n+1} connect the impedance transforming parts 130_{n,n+1} to the resonating parts 120ₙ₊₁, and the switch part 550 connects the impedance transforming part 130_{N,N+1} to the input/output port 512, the signal selecting device 500 functions as a signal selecting device having N resonators. In the case where one branch part 530_{n,n+1} connects the impedance transforming part 130_{n,n+1} to the switch part 550, and the switch part 550 connects the impedance transforming part 130_{n,n+1} to the input/output port 512, the signal selecting device 500 functions as a signal selecting device having n resonators. That is, the number of resonators can be changed by controlling which branch part 530_{n,n+1} is connected to the switch part 550. Therefore, the bandwidth and the in-band and out-band frequency characteristics can be more flexibly adjusted.

### Embodiment 6

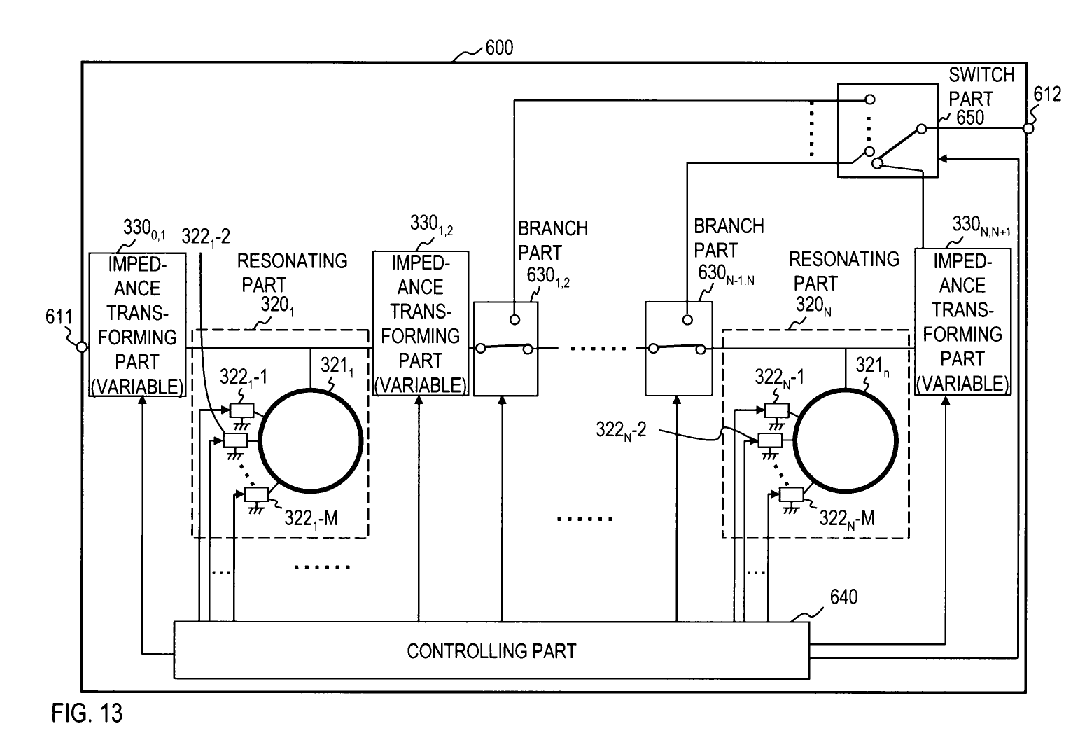

FIG. 13 is a diagram showing an exemplary functional configuration of a signal selecting device according to an embodiment 6. A signal selecting device 600 has the configuration of the signal selecting device 300 according to the embodiment 3 additionally provided with N−1 branch parts 630_{1,2} to 630_{N-1,N} and a switch part 650. The way of connection between the branch parts 630_{1,2} to 630_{N-1,N} and the switch part 650, the way of control, and the effects are the same as those in the embodiment 5.

### Embodiment 7

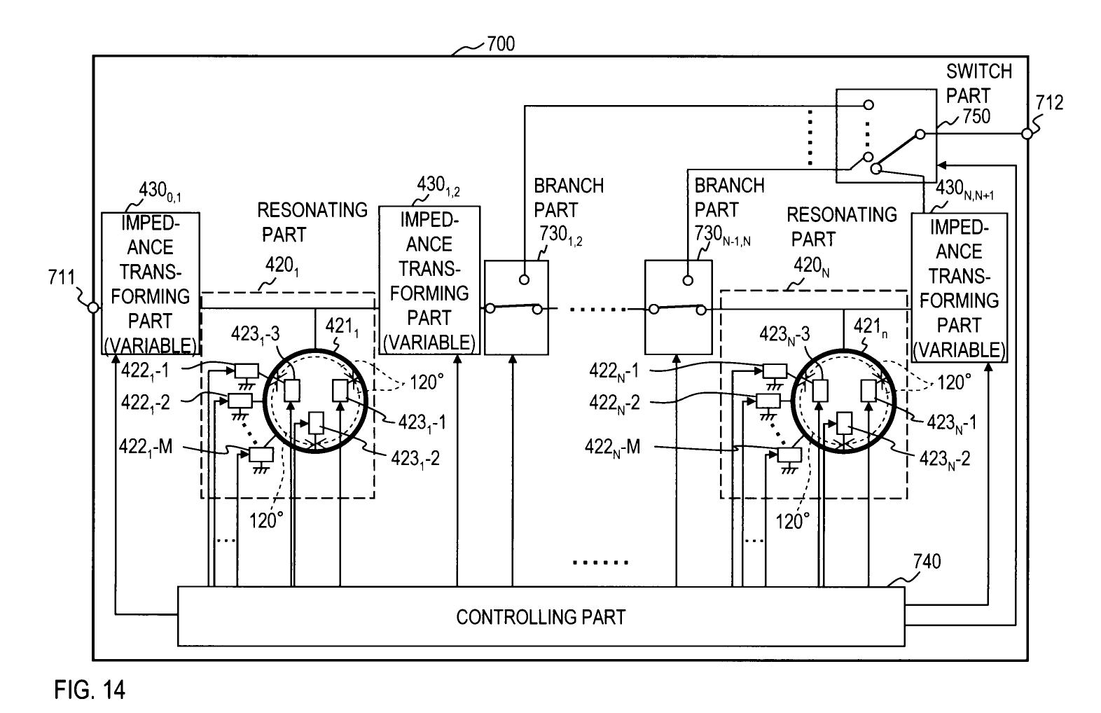

FIG. 14 is a diagram showing an exemplary functional configuration of a signal selecting device according to an embodiment 7. A signal selecting device 700 has the configuration of the signal selecting device 400 according to the embodiment 4 additionally provided with N−1 branch parts 730_{1,2} to 730_{N-1,N} and a switch part 750. The way of connection between the branch parts 730_{1,2} to 730_{N-1,N} and the switch part 750, the way of control, and the effects are the same as those in the embodiment 5.

### Embodiment 8

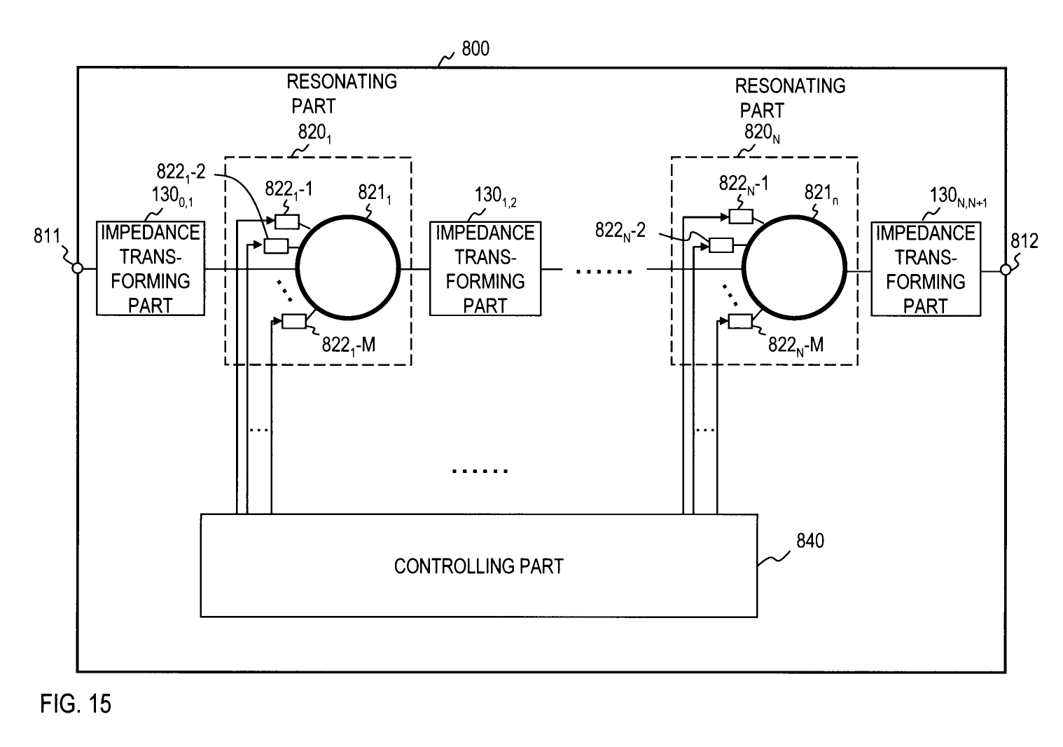

In the embodiments 1 to 7, the ring conductors are connected in parallel to the signal line. In an embodiment 8, the ring conductors are connected in series to the signal line. FIG. 15 is a diagram showing an exemplary functional configuration of a signal selecting device according to this embodiment. A signal selecting device 800 has the same configuration as the signal selecting device 100 according to the embodiment 1 except that the resonating parts 120₁ to 120_{N} are replaced with resonating parts 820₁ to 820_{N}. The resonating part 820ₙ has a ring conductor 821ₙ having a length equal to one wavelength at a resonant frequency or an integral multiple thereof and M switches 822ₙ-1 to 822ₙ-M each of which is connected to a different part of the ring conductor 821ₙ at one end thereof and to a ground conductor at the other end thereof. Two signal lines in the resonating part 820ₙ are connected to the ring conductor 821ₙ at positions spaced apart by a distance equal to an integral multiple of a half of the wavelength at the resonant frequency. That is, the two signal lines are connected to the ring conductor 821ₙ at positions spaced apart by an integral multiple of π in terms of electrical length. A switch 822ₙ-m is not limited to a switch capable of simply making a short circuit but can be a switch capable of making a short circuit via a transmission line having a certain line length or a switch capable of establishing a connection of a transmission line having an open end.

If θ is set at 0, and the part having the impedance Z_{L} is a signal line in FIG. 2, the resulting resonating part is equivalent to the resonating part 820ₙ. With reference to FIG. 2, it has been described that, when θ32 0, the impedance Z_{L} at the resonant frequency of the resonator 120ₙ is equal to the input impedance Zᵢₙ. This means that if the part having the impedance Z_{L} is not a short circuit but a signal line, a signal is transmitted at the resonant frequency, and a filter function (a signal selecting function) is provided. In the case where the ring conductors 821ₙ are connected in series to each other, the paths in which all the switches 822ₙ-m are in the OFF state have a length equal to an integral multiple of a half of the wavelength at the resonant frequency and, therefore, do not affect the frequency characteristics of the respective resonating parts 820ₙ. Therefore, only the paths that include a switch 822ₙ-m in the ON state affect the frequency characteristics of the respective resonating parts 820ₙ. The frequency characteristics of the resonating part 820ₙ differs from the frequency characteristics of the resonating part 120ₙ in this regard.

As described above, in the signal selecting device 800, the resonating parts having a ring conductor and switches can arbitrarily change the susceptance slope parameter highly independently of the resonant frequency, as with the signal selecting device 100 according to the embodiment 1. Therefore, the signal selecting device can be easily designed to have desired characteristics. In addition, the bandwidth and the in-band and out-band characteristics can also changed by changing the susceptance slope parameter of the resonating parts. In practice, in the case where the ring conductors are connected in series, the resonating parts are typically designed using a reactance slope parameter (a parameter in a one-to-one relationship with the susceptance slope parameter).

The signal selecting device 800 shown in FIG. 15 has the configuration of the signal selecting device 100 according to the embodiment 1 in which the resonating parts 120₁ to 120_{N} are replaced with the resonating parts 820₁ to 820_{N}. However, the resonating parts of the signal selecting devices 200, 300, 400, 400′, 500, 600 and 700 according to the embodiments 2 to 7 can also be replaced with the resonating parts 820₁ to 820_{N}. In those cases, the same effect can be achieved.

### Specific Examples of Components

Finally, circuits or elements that can be used to form the components shown in the embodiments 1 to 8 will be described.

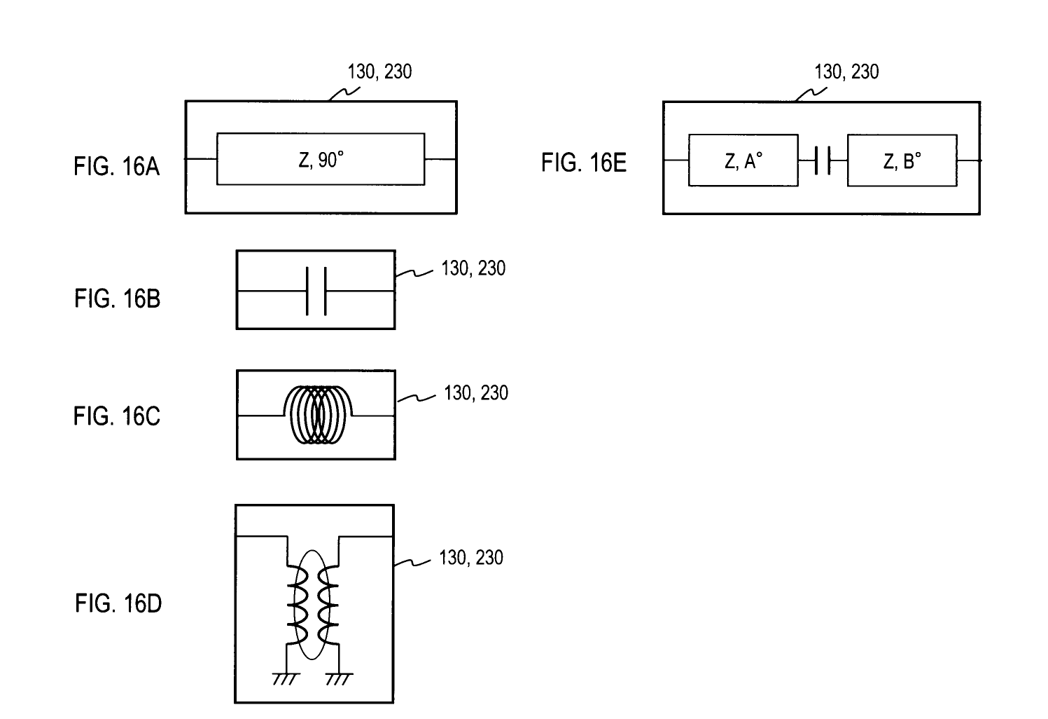

As shown in FIGS. 16A to 16E, the impedance transforming part used in the signal selecting devices according to the present invention can be:

a transmission line having a characteristic impedance of Z and a length equal to a quarter wavelength at the resonant frequency (FIG. 16A);

a capacitor (FIG. 16B);

a coil (FIG. 16C);

lines coupled by electromagnetic induction (FIG. 16D); or

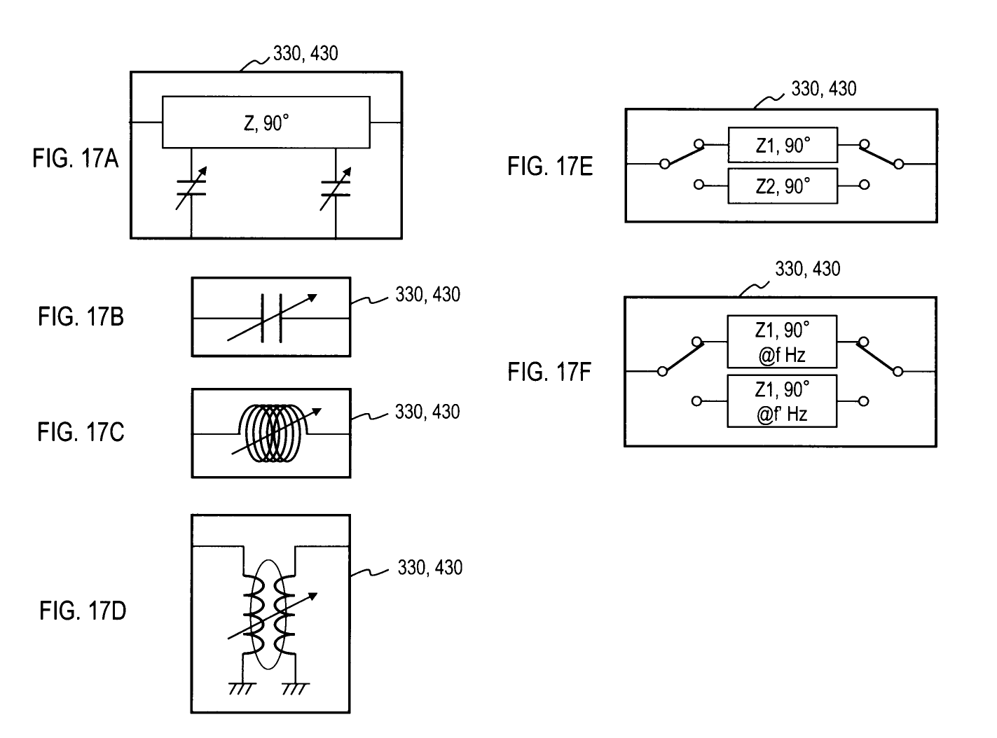

combinations thereof (FIG. 16E). As shown in FIGS. 17A to 17F, the variable impedance transforming circuit can be:

a transmission line having a characteristic impedance of Z and a length equal to a quarter wavelength at the resonant frequency to which variable capacitors are connected in parallel with each other (FIG. 17A);

a variable capacitor (FIG. 17B);

a variable coil (FIG. 17C);

lines variably electromagnetically coupled to each other (FIG. 17D);

two kinds of transmission lines that have a length equal to a quarter wavelength at the resonant frequency and different characteristic impedances and are switched from one to another (FIG. 17E); or

two kinds of transmission lines that have a length equal to a quarter wavelength at different resonant frequencies and the same characteristic impedance and are switched from one to another (FIG. 17F). However, the present invention is not limited to the circuit examples listed above. Furthermore, the resonating part used in the signal selecting device according to the present invention has been described as a circular-ring-shaped line, the resonating part is not limited to the circular-ring-shaped line but can have any ring shape other than a circular ring.

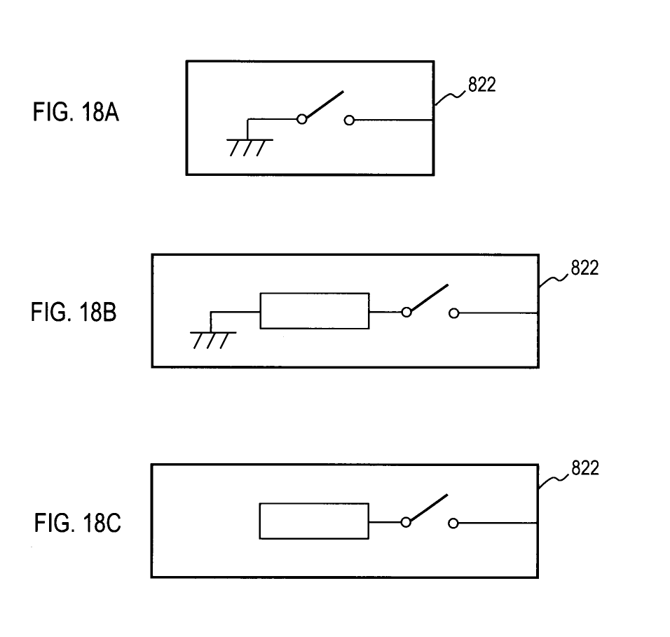

FIGS. 18A to 18C show exemplary configurations of the switch connected to the ring conductor. For example, the switch can be:

a switch that makes a short circuit (FIG. 18A);

a switch that makes a short circuit via a transmission line (FIG. 18B); or

a switch establishes a connection of a transmission line having an open end (FIG. 18C). Different types of switches can be used, or switches having transmission lines of different lengths can be used. Alternatively, a switch having a transmission line whose length can be changed can be used. Furthermore, a switch that establishes a connection to a capacitor or a coil can also be used.

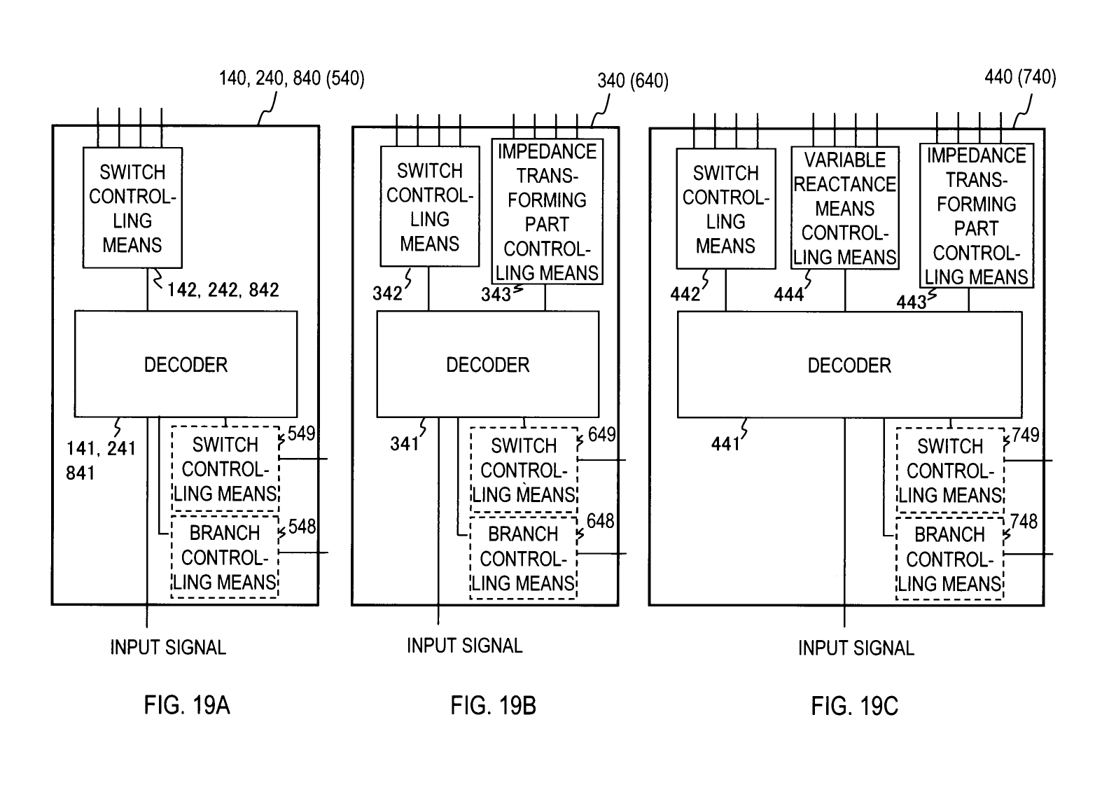

FIGS. 19A to 19C show exemplary functional configurations of the controlling part. FIG. 19A shows an exemplary functional configuration of the controlling parts 140, 240 and 840 according to the embodiments 1, 2 and 8, respectively. A decoder 141, 241, 841 serves to perform switching among a plurality of preset states. When a signal indicating a state is input to the decoder 141, 241, 841, the decoder instructs switch controlling means 142, 242, 842 to select and turn on a switch corresponding to the state. The switch controlling means 142, 242, 842 controls the state of the switches of the resonating parts 120₁ to 120_{N}, 220₁ to 220₃, 820₁ to 820_{N} according to the instruction. FIG. 19B shows an exemplary functional configuration of the controlling part 340 according to the embodiment 3. A decoder 341 controls the characteristics of the impedance transforming parts in addition to serving the same function as the decoder 141, 241, 841. The decoder 341 issues an instruction to impedance transforming part controlling means 343 according to an input signal. The impedance transforming part controlling means 343 changes the characteristics of the impedance transforming parts 330_{0,1} to 330_{N,N+}1 according to the instruction. FIG. 19C shows an exemplary functional configuration of the controlling part 440 according to the embodiment 4. A decoder 441 controls the characteristics of the variable reactance means in addition to serving the same function as the decoder 341. The decoder 441 issues an instruction to variable reactance means controlling means 444 according to an input signal. The variable reactance means controlling means 444 changes the characteristics of the reactance variable means according to the instruction. The dotted lines in FIGS. 19A to 19C represent branch part controlling means 548, 648, 748 and switch part controlling means 549, 649, 749, which are added to the controlling part in the case where the signal selecting device has the branch parts and the switch part as shown in the embodiments 5 to 7. In this case, the controlling part also controls the branch parts and the switch part. Therefore, the decoder 141, 241, 341, 441, 841 also issues an instruction to the branch part controlling means 548, 648, 748 and the switch part controlling means 549, 649, 749 according to the input signal. The branch part controlling means 548, 648, 748 and the switch part controlling means 549, 649, 749 change the state of connection between the branch parts and the switch part according to the instruction.

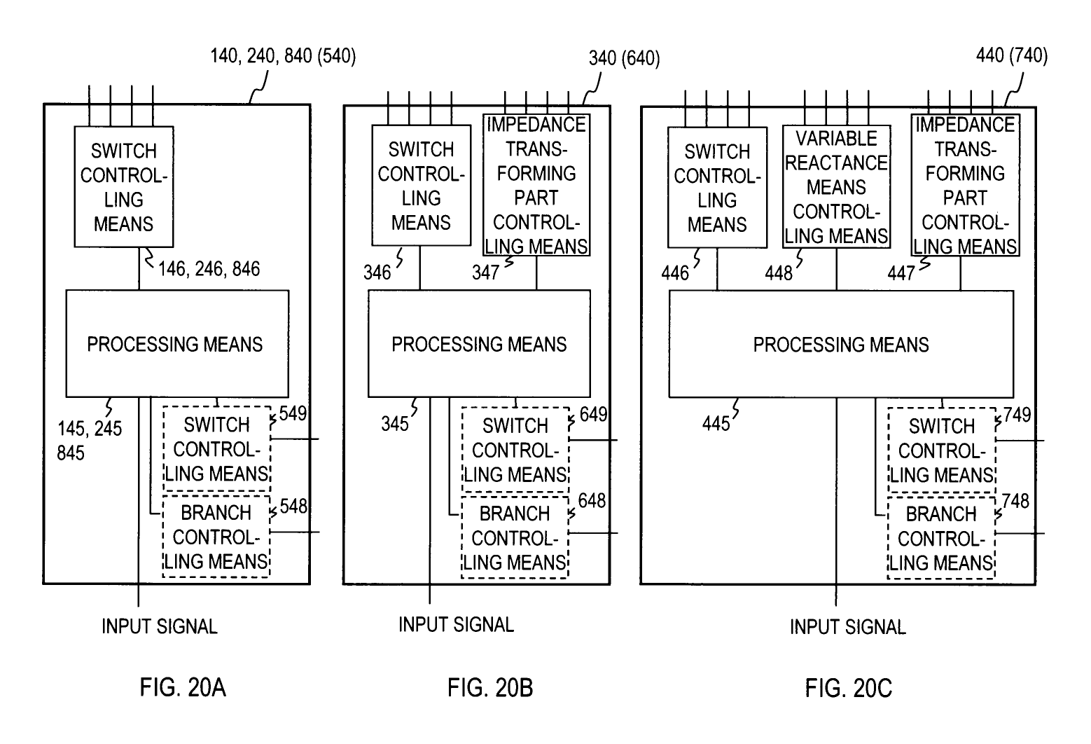

FIGS. 20A to 20C show other exemplary functional configurations of the controlling part. FIG. 20A shows an exemplary functional configuration of the controlling parts 140 and 240 according to the embodiments 1 and 2, respectively. Processing means 145, 245 receives the bandwidth w and the in-band and out-band characteristics (whether the characteristics is Butterworth characteristics or not, whether the characteristics is Chebyshev characteristics or not, what decibel the ripple is in the case of Chebyshev characteristics, or the like) as an input signal. The processing means 145, 245 determines which switch is to be turned on based on the input signal and issues an instruction to switch controlling means 146, 246. The switch controlling means 146, 246 controls the state of the switches of the resonating parts 120₁ to 120_{N}, 220₁ to 220₃ according to the instruction. FIG. 20B shows an exemplary functional configuration of the controlling part 340 according to the embodiment 3. Processing means 345 controls the characteristics of the impedance transforming parts in addition to serving the same function as the processing means 145, 245. The processing means 345 determines the way of changing the characteristics of the impedance transforming parts based on the input signal and issues an instruction to impedance transforming part controlling means 347. The impedance transforming part controlling means 347 changes the characteristics of the impedance transforming parts 330_{0,1} to 330_{N,N+1} according to the instruction. FIG. 20C shows an exemplary functional configuration of the controlling part 440 according to the embodiment 4. Processing means 445 controls the characteristics of the variable reactance means in addition to serving the same function as the processing means 345. An input signal to the processing means 445 includes information about the center frequency. The processing means 445 determines the way of changing the characteristics of the variable reactance means based on the input signal and issues an instruction to variable reactance means controlling means 448. The variable reactance means controlling means 448 changes the characteristics of the reactance variable means according to the instruction. The dotted lines in FIGS. 20A to 20C represent the branch part controlling means 548, 648, 748 and the switch part controlling means 549, 649, 749, which are added to the controlling part in the case where the signal selecting device has the branch parts and the switch part as shown in the embodiments 5 to 7. The processing means 145, 245, 345, 445, 845 also issues an instruction to the branch part controlling means 548, 648, 748 and the switch part controlling means 549, 649, 749 according to the input signal. The branch part controlling means 548, 648, 748 and the switch part controlling means 549, 649, 749 change the state of connection between the branch parts and the switch part according to the instruction.

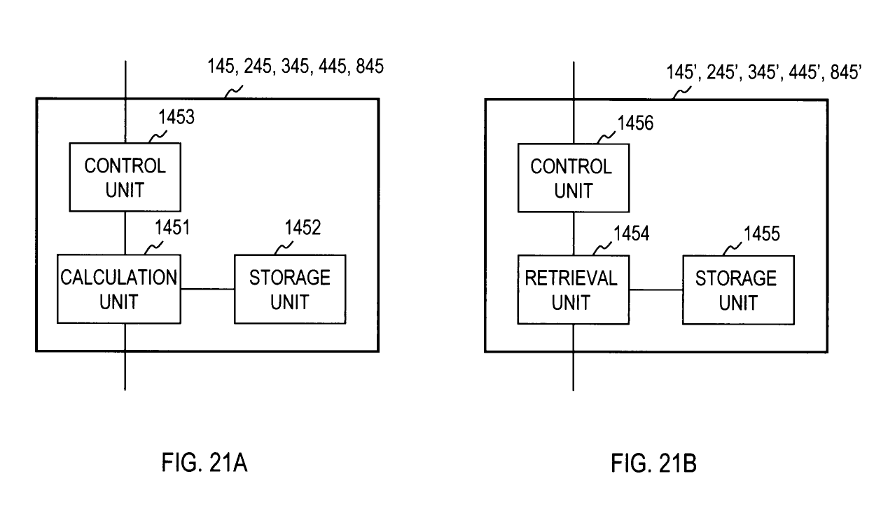

FIGS. 21A and 21B show exemplary functional configurations of the processing means. FIG. 21A shows an example of the processing means composed of a calculation unit, a storage unit and a control unit. A calculation unit 1451 determines the susceptance slope parameter according to the formulas (4) to (6) using information, such as the bandwidth and the in-band and out-band characteristics. Then, the calculation unit 1451 determines θ from the susceptance slope parameter. Furthermore, the calculation unit 1451 selects a switch closest to the determined θ based on switch position information or the like stored in a storage unit 1452 and instructs a control unit 1453 to turn on the selected switch. According to the instruction, the control unit 1453 controls the switch controlling means, the impedance transforming part controlling means, the variable reactance means controlling means, the branch part controlling means and the switch part controlling means. FIG. 21B shows an example of the processing means composed of a retrieval unit, a storage unit and a control unit. In this case, a storage unit 1455 stores a lookup table, for example. A retrieval unit 1454 retrieves a condition closest to the condition indicated by an input signal from the lookup table and obtains information about the current state of the switch, the impedance transforming part, the variable reactance means, the branch part controlling means and the switch part controlling means. Then, the retrieval unit 1454 issues an instruction to a control unit 1456. Alternatively, the examples shown in FIGS. 21A and 21B can be combined to each other. For example, if the condition indicated by the input signal is found in the lookup table, the condition can be used, and if the condition indicated by the input signal is not found in the lookup table, calculation can be performed.

As the impedance transforming part controlling means that controls the impedance transforming parts capable of changing the characteristics, circuits described below can be used. In the case where the impedance transforming parts change the characteristic impedance in a discrete manner (a case where a plurality of switches are used to control the characteristics, for example), a digital variable impedance transforming circuit controlling circuit can be used as the impedance transforming part controlling means. In the case where the impedance transforming part change the characteristic impedance in a continuous manner (a case where a varactor using a diode is used, for example), a variable impedance transforming circuit controlling circuit, such as a D/A converter, can be used as the impedance transforming part controlling means. The same holds true for the variable reactance means controlling means.

What is claimed is:

1. A signal selecting device, comprising:
two input/output ports;
a plurality of resonating parts having a ring conductor having a length equal to one wavelength at a resonant frequency or an integral multiple thereof and a plurality of switches each of which is connected to a different part of said ring conductor at one end and to a ground conductor at the other end;
a plurality of impedance transforming parts that adjusts an impedance; and
a controlling part that controls the state of said switches,
wherein said resonating parts are disposed in series between said two input/output ports, and said impedance transforming parts are disposed between said input/output ports in such a manner that the impedance transforming parts at the both ends are disposed between the input/output port and the resonating part and the remaining impedance transforming parts are disposed between the resonating parts.

2. A signal selecting device according to claim 1, wherein at least one of said impedance transforming parts is capable of changing the characteristics, and
said controlling part is capable of controlling the characteristics of said at least one impedance transforming part capable of changing the characteristics.

3. A signal selecting device according to claim 1, wherein said signal selecting device has an odd number of said resonating parts,
said impedance transforming parts have the same characteristics.

4. A signal selecting device according to claim 3, wherein all of said impedance transforming parts are capable of changing the characteristics, and
said controlling part is capable of controlling the characteristics of all of said impedance transforming parts while maintaining the same characteristics.

5. A signal selecting device according to claim 1, wherein said signal selecting device has an even number of said resonating parts,
at least one of said impedance transforming parts is capable of changing the characteristics, and
said controlling part is capable of controlling the characteristics of said at least one impedance transforming part capable of changing the characteristics.

6. A signal selecting device according to claim 5, wherein said at least one impedance transforming part capable of changing the characteristics includes the impedance transforming part disposed at the center.

7. A signal selecting device according to claims 2, 4, 5 or 6, wherein said resonating parts have three or more variable reactance means connected to said ring conductor, and
said controlling part is capable of controlling the state of said variable reactance means.

8. A signal selecting device according to claim 1, further comprising:
one or more branch parts that have three terminals and switches the state of connection between a predetermined terminal and the remaining terminals; and
a switch part that has three or more terminals and switches the state of connection between a predetermined terminal and the remaining terminals,
wherein said switch part is disposed between one of said input/output port and said impedance transforming parts in a state where the predetermined terminal is connected to said input/output port,
said branch parts are disposed between said impedance transforming parts and said resonating parts in a state where the predetermined terminal is connected to the side of the other input/output port,
one of the remaining terminals of said branch parts is connected to one of the remaining terminals of said switch part, and
said controlling part is capable of controlling the state of connection between said branch parts and said switch part.
